(19) United States
(12) Patent Application Publication
(10) Pub. No.: US 2014/0218744 A1
(43) Pub. Date: Aug. 7, 2014

(54) SYSTEMS, METHOD AND COMPUTER-ACCESSIBLE MEDIUM WHICH UTILIZE SYNTHETIC APERTURE(S) FOR EXTENDING DEPTH-OF-FOCUS OF OPTICAL COHERENCE TOMOGRAPHY IMAGING

(71) Applicants: JOHANNES F. DE BOER, Amstelveen (NL); JIANHUA MO, Jiangsu Province (CN); MATTIJS DE GROOT, Haarlem (NL)

(72) Inventors: JOHANNES F. DE BOER, Amstelveen (NL); JIANHUA MO, Jiangsu Province (CN); MATTIJS DE GROOT, Haarlem (NL)

(73) Assignee: The General Hospital Corporation, Boston, MA (US)

(21) Appl. No.: 14/170,805

(22) Filed: Feb. 3, 2014

Related U.S. Application Data
(60) Provisional application No. 61/759,580, filed on Feb. 1, 2013.
(60) Provisional application No. 61/784,991, filed on Mar. 14, 2013.

(51) Int. Cl. G01B 9/02

(52) U.S. Cl. CPC G01B 9/02091
USPC 356/479

(57) ABSTRACT

An exemplary apparatus can be provided for generating at least one image of a structure. The apparatus can include at least one first arrangement that has a structural configuration with a first aperture and a second aperture. At least one detector second arrangement can b provided which is configured to detect (i) a first electro-magnetic signal provided to or from the structure via the first aperture, and (ii) a second electromagnetic signal provided to or from the structure via the second aperture. The first and second signals can be associated with data regarding at least one portion of the structure. The exemplary apparatus can further include at least one processing third arrangement which is configured to combine an amplitude and a phase of each of the first and second signals with one another to form a combined amplitude and a combined phase of a combined signal, and then generate the image(s) based on the combined signal.

### CROSS-REFERENCE TO RELATED APPLICATION(S)

This application relates to and claims priority from U.S. Patent Application Ser. No. 61/759,580 filed Feb. 1, 2013, and U.S. Patent Application Ser. No. 61/784,991 filed Mar. 14, 2013, the entire disclosure of which is incorporated herein by reference.

### FIELD OF THE DISCLOSURE

The present disclosure relates to exemplary embodiments of systems, methods and computer-accessible medium for optical imaging and computer-accessible medium associated therewith, and in particular to systems, methods and computer-accessible medium which utilize synthetic aperture(s) for extending depth-of-focus of optical coherence tomography imaging.

### BACKGROUND INFORMATION

Optical coherence tomography (“OCT”) provides depth-resolved imaging of biological scattering medium. It has been developed in both time domain and Fourier domain. The conventional time domain system is described in detail by D. Huang et al. [see, e.g., Ref. 1]. In general, OCT systems and methods measure a complex field of the light backscattered from multiple depths in samples through an interferometric detection scheme with a local oscillator (e.g., a reference light field). The Fourier transform of the measured interference spectrum produces a depth-profile (called A-scan) of the sample.

The Fourier domain OCT procedures and/or configurations can be implemented in two ways, which are spectrometer based (called spectral domain OCT, described, in U.S. Patent Publication No. 2005/0018201) and swept source based (which can be called optical frequency domain imaging, described in U.S. Patent Publication No. 2006/0244973). The axial resolution of an OCT image at moderate numerical aperture is determined primarily by the central wavelength and optical bandwidth of the light source and consequently remains constant over the entire imaging depth. In comparison, the transverse resolution is dependent on the light wavelength λ, beam diameter d and the objective focal length f. In the focus, the lateral resolution can be given by the focus diameter: Δr=4λf/πd. The depth range over which the lateral resolution is maintained within a factor of \sqrt{2} is given by the Rayleigh range (zR=πΔr²/2λ). The distance over which the lateral resolution can be maintained (e.g., the depth of focus) can be, in general, defined by twice the Rayleigh range. Current broadband laser sources enable axial resolutions below 10 μm over several centimeters of imaging depth. However, with standard Gaussian beams it is not possible to maintain a similar transverse resolution over a depth range of more than a few hundred micrometers. The relatively short focal-depth of imaging optics limits the application of high lateral resolution OCT to thin slices,

Various methods have been proposed to address the limited depth-of-focus of OCT, including dynamic focus [see, e.g., Refs. 4, 5], multi-focus [see, e.g., Ref. 6], Bessel beam illumination with axicon lenses [see, e.g., Refs. 7, 8], phase apodization [see, e.g., Ref. 9], interferometric synthetic aperture methods (ISAM) [see, e.g., Ref. 10], deconvolution methods [see, e.g., Ref. 11], and scalar diffraction models [see, e.g., Ref. 12].

Another exemplary technique, e.g., self-interference fluorescence microscopy, uses the wavefront curvature of the collected fluorescence light at the objective's backfocal plane to determine the depth position of a fluorophore in samples, as described in U.S. Patent Publication No. 2009/0059360. For example, when the source is located in the focal plane, the wavefront at the backfocal plane of the objective is planar. In comparison, when the source is slightly out of focus, the wavefront at the backfocal plane of the objective becomes concave (object before the focal plane) or convex (object after the focal plane). The curvature of the wavefront leads to a subtle optical path length difference between the central part and the edge part of the beam. This subtle optical path length difference can be used to determine the distance of the object to the real focal plane.

There may exist some deficiencies associated with those reported depth-of-focus extension methods above, and it may be preferable to address and/or overcome such deficiencies.

### SUMMARY OF EXEMPLARY EMBODIMENTS

To address and/or overcome such deficiencies, exemplary embodiments of the present disclosure can be provided, e.g., such as systems, methods and computer-accessible medium, which utilize synthetic aperture(s) for extending depth-of-focus of optical coherence tomography imaging, according to exemplary embodiments of the present disclosure.

For example, according to an exemplary embodiment of the present disclosure, it is possible to separate the light field from different optical apertures in the optical imaging system by using a special phase-retarding, optical element. The complex light field (or a field of another electro-magnetic radiation) through different optical apertures can be obtained by an interferometric detection scheme and/or configuration, with a local oscillator field. This allows for light-field manipulation and re-synthesis to improve the lateral resolution and extend the depth-of-focus.

According to an exemplary embodiment of the present disclosure, exemplary embodiments of systems, methods and computer-accessible medium can be provided to separate the detected light fields from different optical apertures through adding different delays to the light fields from different optical apertures. This can be performed by, e.g., inserting a phase plate, for instance an annular phase plate into the sample arm at the back focal plane of the imaging lens. The annular phase plate can be made in polycarbonate, plastic, glass, or other materials which have a transmission for the OCT light. The light or other electro-magnetic radiation through the solid edge part of the phase plate can be delayed, as compared to the light or other electro-magnetic radiation through the hollow center of the phase plate Alternatively or in addition, the light or other electro-magnetic radiation through the hollow center of the phase plate can be delayed as compared to the solid edge part of the phase plate. The delay can be determined by the optical thickness of the phase plate, and can lead to a depth-separation of the signals formed by the light through the edge part and the hollow center in the OCT A-lines.

According to some exemplary embodiment of the present disclosure, the wavefront of the collected light (or other electro-magnetic radiation) at the backfocal plane of the objective can be curved when the scattering object is out-of-focus. This curvature can induce a small extra path length difference between the edge part and central part of the beam, e.g., with respect to a delay with the depth separation by the phase plate. This small extra path length difference can be corrected by applying a constant phase to the detected tight field of the edge part of the beam. Then, the detected OCT signals formed by the central part and edge part of the beam can be summed to produce a new image with defocus effect corrected. The lateral resolution of the image is consequently improved.

According to further exemplary embodiment of the present discourse, due to the reflection mode of the OCT measurement, three separate signals from different optical apertures can be acquired in parallel in a single A-line, when a phase plate is inserted into the sample arm. This can be because the phase plate creates three different paths for the sample arm light to reach the detector via a scattering object in the sample: the first light path passes through the center of the phase plate both on the way to the scattering object and back. The second path can pass through the center on the way to the scattering object and navels back through the edge, or, passes through the edge on the way to the scattering object and travels back through the center. Finally, the third light path can pass through the edge of the phase plate both on the way to the scattering object and back. The three different light paths can cause different light propagation path lengths, which can encode the three images into different depths of a single OCT cross-section image. This depth-encoding can facilitate a manipulation of the phase of the three signals to correct the phase difference due to the wavefront curvature. If a phase plate of different shape and with multiple optical thickness is used, more than three signals can be produced that can be manipulated to improve the lateral or depth resolution of the imaging.

In one exemplary embodiment of the present disclosure, an exemplary apparatus can be provided for generating at least one image of a structure. The apparatus can include at least one first arrangement that has a structural configuration with a first aperture and a second aperture. At least one detector second arrangement can be provided which is configured to detect (i) a first electro-magnetic signal provided to or from the structure via the first aperture, and (ii) a second electro-magnetic signal provided to or from the structure via the second aperture. The first and second signals can be associated with data regarding at least one portion of the structure. The exemplary apparatus can further include at least one processing third arrangement which is configured to combine an amplitude and a phase of each of the first and second signals with one another to form a combined amplitude and a combined phase of a combined signal, and then generate the image(s) based on the combined signal.

The first signal and/or the second signal can be an optical coherence tomography signal. The first and second signals can be provided at different depths of an optical coherence tomography depth profile of the structure. The structural configuration can include a third aperture, and the detector second arrangement(s) can be configured to detect a third electro-magnetic signal associated with data regarding the portion of the structure provided from the structure via, the third aperture. The processing third arrangement can be further configured to combine an amplitude and a phase of each of the first, second and third signals with one another to form the combined amplitude and the combined phase of the combined signal. Prior to forming the combined amplitude and the combined phase of the combined signal, the processing third arrangement can be configured to actively manipulate the phase of the first signal, the second signal and/or the third signal. An amount of phase manipulation of at least one of the first signal, the second signal or the third signal is optimizable with a criteria related to at least one property of the image at a particular depth. The processing third arrangement can be further configured to actively manipulate the phase of the first signal, the second signal and/or the third signal differently for separate sections of the structure which are provided at different depths thereof.

According to still another exemplary embodiment of the present disclosure, the structure can be a biological structure. The structural configuration can include a material that provides (i) the first and second apertures therein, and (ii) a path length of the first signal that is different from a path length of the second signal. A difference between the path lengths of the first and second signals can be greater than a length or a thickness of the portion of the structure being imaged. The material can include a glass, a phase grating, a deformable mirror, and/or a spatial phase modulator. The detector second arrangement can include at least one single-mode fiber which collects the first and second signals. The first arrangement can be provided in an endoscope. The structural configuration can have first and second structures, the first structure can include the first aperture, and the second structure can include the second aperture. The first arrangement can be provided in a microscope.

Further features and advantages of the exemplary embodiment of the present disclosure will become apparent taken in conjunction with the accompanying figures and drawings and upon reading the following detailed description of the exemplary embodiments of the present disclosure, and the appended claims.

### BRIEF DESCRIPTION OF DRAWINGS

Further objects, features and advantages of the present disclosure will become apparent from the following detailed description taken in conjunction with the accompanying figures showing illustrative embodiments of the present disclosure, in which:

FIGS. 1(a)-1(d) are to set of diagrams illustrating an exemplary principle of a depth-encoded synthetic aperture method for extending depth-of-focus of optical coherence tomography according to an exemplary embodiment of the present disclosure;

FIG. 2 is a schematic diagram of a synthetic aperture OCT system according to an exemplary embodiment of the present disclosure;

FIG. 3 is a diagram of a refocusing process implementing exemplary synthetic aperture OCT techniques and systems according to an exemplary embodiment of the present disclosure;

FIG. 4(a)-4(h) is a set of exemplary intensity images produced by truncated Gaussian beam OCT, conventional full Gaussian beam OCT, and exemplary synthetic aperture OCT techniques and systems, e.g., when phantom is moved away from the objective at a physical step of about 80 μm;

FIGS. 5(a)-5(c) are exemplary lateral profiles of three selected spheres for different displacement of phantom relative the objective for truncated Gaussian beam, full Gaussian beam and exemplary synthetic aperture OCT imaging techniques and systems;

FIGS. 6(a)-6(d) are exemplary graphs of a full width at half maximum (FWHM) of the three selected spheres as a function of the phantom displacement relative to the objective for truncated Gaussian beam, full Gaussian beam and exemplary synthetic aperture OCT imaging techniques and systems, and point spread function of full Gaussian beam imaging generated from physical optics simulation;

FIGS. 7(a)-7(c) are exemplary graphs of scattered energy of the spheres in truncated Gaussian beam imaging, full Gaussian beam imaging and refocused imaging;

FIG. 8 is an exemplary graph providing a phase factor applied to middle and bottom images for the image refocusing,

FIG. 9 is an exemplary graph illustrating a system efficiency of traditional Gaussian beam OCT imaging as opposed to exemplary synthetic aperture OCT imaging techniques and systems;

FIG. 10 is an illustration of a set of exemplary embodiments of phase plate design for synthetic aperture OCT according to the present disclosure;

FIG. 11 is an illustration of as set of exemplary embodiments of sample arm designs for implementing synthetic aperture OCT techniques and systems according to the present disclosure; and

FIGS. 12(a)-12(c) are side schematic views of exemplary embodiments of OCT catheter designs for implementing synthetic aperture OCT according to the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited, by the particular embodiments illustrated in the figures, or the appended claims.

### DETAILED DESCRIPTION OF EXEMPLARY EMBODIMENTS

### Exemplary Procedures of Synthetic Aperture OCT Imaging

The exemplary embodiments of the present disclosure can extend the depth-of-focus of the OCT image. In addition, the exemplary embodiments of the present disclosure also provides various different phase retarding optics designs and different sample arm designs for implementing synthetic aperture OCT.

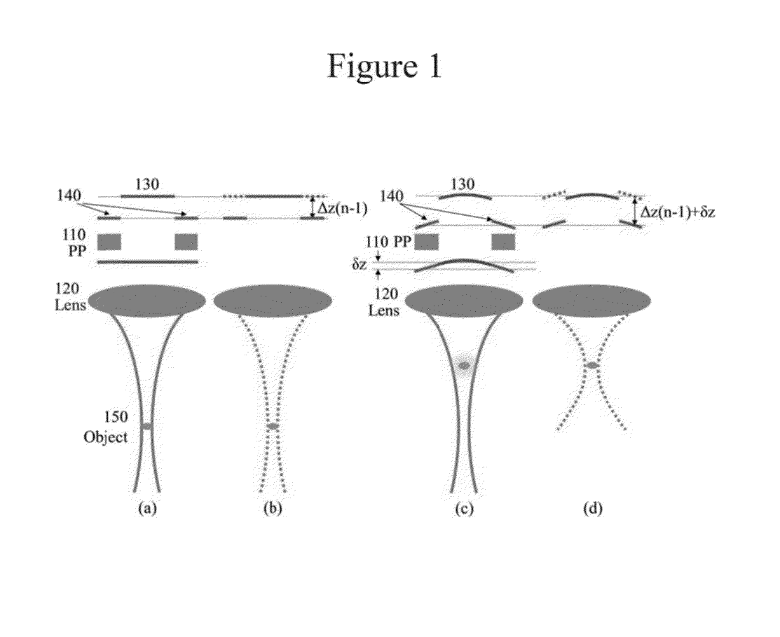

According to an exemplary embodiment of the present disclosure, as shown in FIGS. 1(a)-1(d), the annular phase plate (110) positioned at the backfocal plane of the objective (120) separates the collected light wavefront into two parts: central beam (130) through the central hole of the phase plate, and edge beam (140) through the solid edge part of the phase plate (110). When the object (150) is in-focus, the collected light goes through the phase plate (110) with a planar wavefront. The edge beam (140) is delayed with respect to the central beam (130) due the longer optical path length, given by Δz(n−1), with Δz the thickness of the phase plate (110), and n the refractive index of the phase plate (110) (see FIG. 1(a)). In a single OCT B-scan, the central beam image and the edge beam image are encoded to two different depth locations separated by Δz(n−1). A new image can be constructed by correcting the delay (or depth-separation Δz(n−1) in post processing and coherently adding those two images (see FIG. 1(b)). The newly constructed image can have a comparable lateral resolution as the image acquired without the phase plate (110). When the object (150) is defocused (see FIG. 1(c)) (in this example—above the focal plane), the edge beam (140) can undergo the same delay due to the phase plate (110) as in the in-focus case. In addition, a small extra delay (δz) can occur due to the curvature of the wavefront (130, 140). An image with an improved focus can be constructed by correcting the edge beam (140) wavefront for both the terms Δz(n−1) and δz (FIG. 1(d)).

Mathematically, the detected OCT signal I(k) in spectral domain OCT and optical frequency domain imaging (OFDI) for a single scattering object can be expressed by the following equation:

I(k)=Iᵣ(k)+Iₛ(k)+2\sqrt{Iᵣ(k)Iₛ(k)}α cos(2kz) (0)

where k is the wave number, α is the square root of the scattering object reflectivity at depth z. Iᵣ(k) and Iₛ(k) on the right-hand side of Eq. (1) are the wavelength-dependent intensity reflected from the reference arm and sample arm, respectively, and are also called DC terms. The third term is the interference between the reference arm and sample arm that contains the depth information The DC terms are from now on omitted since they carry no depth information and only the interference term is retained.

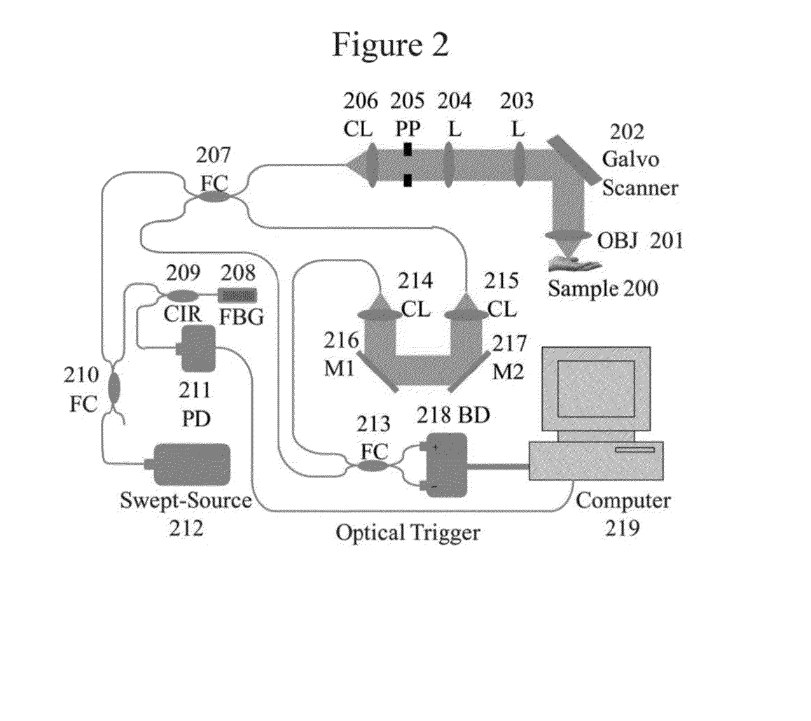

According to an exemplary embodiment of the system according to the present disclosure, as shown in FIG. 2, when a phase plate (PP) (205) is inserted into the sample arm, there can be, e.g., three or more different paths for the sample arm light to reach the detector (218) via a scattering object in the sample (200): the first light path passes through the center of the phase plate PP (205) both on the way to the scattering object and back. The second path can pass through the center on the way to the scattering object and travels back through the edge, or, can pass through the edge on the way to the scattering object and travels back through the center. Finally, the third light path can pass through the edge of the phase plate (205) both on the way to the scattering object and back. These three exemplary paths can generate three different depth encoded images, where each image corresponds to the light detected through a distinct circular (or annular) aperture or a combination of apertures. The interference of the sample arm light with a local oscillator field (e.g., the reference field) can provide both the amplitude and the phase of these three images.

The interference term for a single object with the phase plate in the beam path is thus given by:

$$I ( k ) = \sqrt{{I}_{r} ( k ) {I}_{s} ( k )} α \{ \begin{matrix}[ \begin{matrix}exp ( i 2 kz ) K + \\ exp ( i 2 kz + i k ( Δ z ( n - 1 ) + δ z ) ) K + \\ exp ( i 2 kz + i k 2 ( Δ z ( n - 1 ) + δ z ) )\end{matrix} ] + \\ C . C\end{matrix} \} \qquad ( 0 )$$

where Δz(n−1) is the single pass optical path length difference between the central beam (130) and edge beam (140). C.C. indicates the complex conjugate, and δz is the small extra optical path length difference between the central beam (130) and edge beam (140) resulting from the defocus-induced wavefront curvature, which becomes zero when the object is in focus.

To facilitate the exemplary image processing of summing coherently the three terms in Eq. (2) into a single image, the k value can be written as k=k₀+Δk for the terms that contain products with Δz and δz As an example, the second term on the right hand side of Eq. (2) (the middle image) can be rewritten as:

I(k)=\sqrt{Iᵣ(k)Iₛ(k)}α exp(i2kz)exp(ik₀Δz(n−1)+ik₀δz+iΔkΔz(n−1)+iΔkδz)+C.C. (0)

The wavelength-dependent phase term (Δkδz) can be neglected since δz is smaller than a wavelength, and the optical bandwidth or the tuning range of the laser source is in general smaller than ±5% of the central wavelength. Then, Eq. (3) can be written as follows, with the constant phase (k-independent) terms separated out:

I(k)=exp(iψ_{middle})\sqrt{Iᵣ(k)Iₛ(k)}α exp(i2kz)exp(iΔkΔz(n−1))+C.C. with ψ_{middle}=k₀Δz(n−1)+k₀δz (0)

The third term on the right hand side of Eq. (2) (the bottom image) is now given by:

I(k)=exp(iψ_{bottom})\sqrt{Iᵣ(k)Iₛ(k)}α exp(i2kz)exp(i2ΔkΔz(n−1))+C.C. with ψ_{bottom}=2k₀Δz(n−1)+2k₀δz (0)

compared to Eq. (1) for the OCT signal detected without phase plate, an extra oscillation phase (ΔkΔz(n−1)) and a constant phase ψ are added in Eq. (4) and (5), resulting from the phase plate and defocus effect. The phase term (k₀δz) is negative when the focal plane is below the imaging target and positive when the focal plane is above the imaging target. From the description above, it is possible to extract the individual light field from different optical apertures from the measured OCT B-scan.

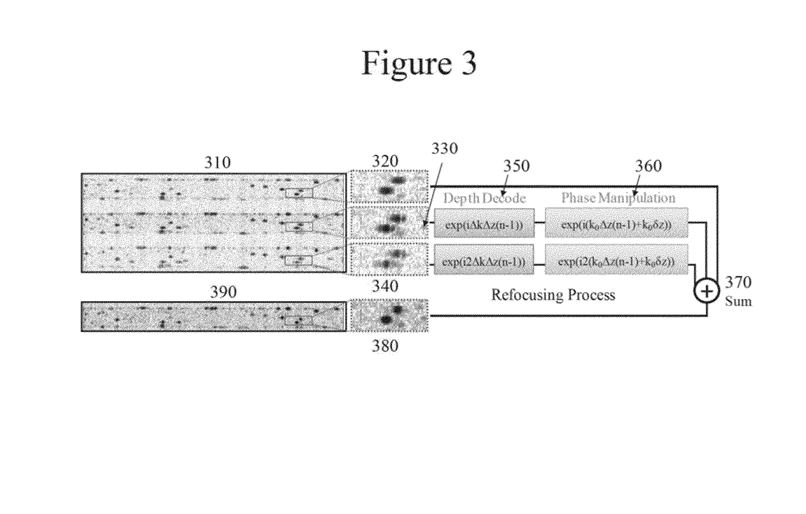

FIG. 3 illustrates a diagram of an exemplary refocusing process according to an exemplary embodiment of the present disclosure. For example, three images can be clearly seen in parallel in single B-scan (310). The top image can be formed by the light through shortest optical path (incident and backscattered through the central hole of the phase plate (205)). The middle image can be attributed to the light incident through the central hole and backscattered through the phase plate (205) or the other way around. The bottom image can be attributed to the light (incident and backscattered through the solid edge part of the phase plate (205)). The refocusing procedure and/or method according to an exemplary embodiment of the present disclosure can include the following steps:
(a) Exemplary depth-decoding (350) the middle and bottom images to the depth position of the top image to correct the depth-offset due to the phase plate (Δz(n−1)). This can be done, e.g., using the Fourier shift-theorem:

I_{T}(k)=I(k)exp(iΔkΔφ) (0)
where I(k) and I_{T}(k) are the spectrum before and after the frequency-shift, respectively; and Δφ is the frequency-shift factor for depth-decoding (350) the middle and bottom images relative to the top image in the spectral domain. In theory, Δφ is equal to Δz(n−1) for the middle image and to 2Δz(n−1) for the bottom image. In the experimental calculation, the frequency-shift factor Δφ can, for example, be determined by maximizing the energy of the sum of the magnitude of the top image with the shifted middle and bottom images (incoherent sum).
(b) Exemplary correction of the defocus-induced additional phase change ψ (360). This IS phase change can be wavenumber-independent and therefore can be corrected simply by applying a constant phase factor to the Fourier-transformed spectrum which undergoes a frequency-shift in the first step. Then, all three complex images can be coherently summed to reconstruct a new image This can be expressed as

S_{refocused}=Sₜₒₚ+S_{middle} exp(−ψ_{middle})+S_{bottom} exp(−iψ_{bottom}) (0)
where S is the original complex Fourier-transformed B-scan S_{middle} and S_{bottom} are the complex Fourier-transformed B-scans with the middle and bottom images being depth-decoded (350), respectively; ψ_{middle} and ψ_{bottom} are phase factors (0˜2π) applied to S_{middle} and respectively. In principle, ψ_{middle} and ψ_{bottom} are the wrapped phase of k₀Δz(n−1)+k₀δz and 2(k₀Δz(n−1)+k₀δz). In practical calculation, these two phase factors (ψ_{middle} and ψ_{bottom}) above can be determined by maximizing the energy of the reconstructed or refocused image (S_{refocused}). The exemplary images with two beads (320,330,340, 380) as an example in the windows shown in FIG. 3 can provide detailed insight into the reconstruction process and how the focus is improved. The phase manipulation leads to constructive interference on the center part of the focus spot and destructive interference on the edge part of the focus spot (i.e., side lobe in middle and bottom images).

This exemplary combined constructive and deconstructive interference process can improve the lateral resolution.

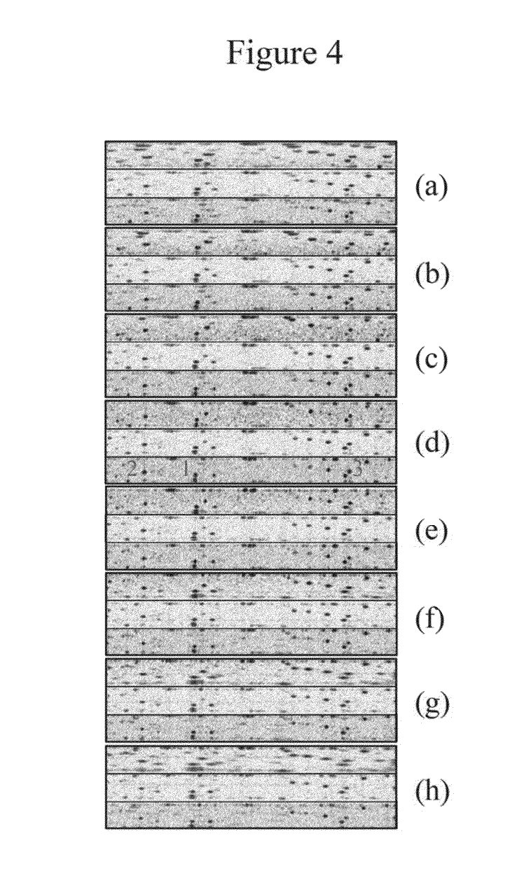

FIG. 4 shows exemplary illustrations of a direct comparison between three different imaging modes for different positions of the lens focus: (1) the full beam image without phase plate, (2) the truncated Gaussian beam image (e.g., top image of the original B-scan), and (3) the refocused image, where the three images are shown as the top, middle and bottom in each subfigure. The subfigures (FIGS. 4(a)-4(h)) are exemplary images of the phantom being moved away from the objective (201) at 80-μm step size. Due to the refractive index mismatch, the step size should be scaled by the refractive index of the phantom to represent the actual focal plane shift [see, e.g., Ref 9]. Thus, the physical phantom movement of 80 μm can lead to a 115.2-μm displacement of the focal plane. As shown in FIGS. 4(a)-4(h), the spheres in the truncated beam images appeared to have a very slow change in width over the defocus process. This can be because the light beam is truncated from 3.4 mm to 1.8 mm (diameter) by the phase plate which results in an extension of Rayleigh range at the cost of an increased, lateral focal spot size. In contrast, the corresponding full beam image without phase plate (205) experienced a much more rapid change in the sphere's width during the same defocus process. For the refocused images, as compared to the full beam image, the refocused image had comparable focus size and maintained the focus over a much larger depth range.

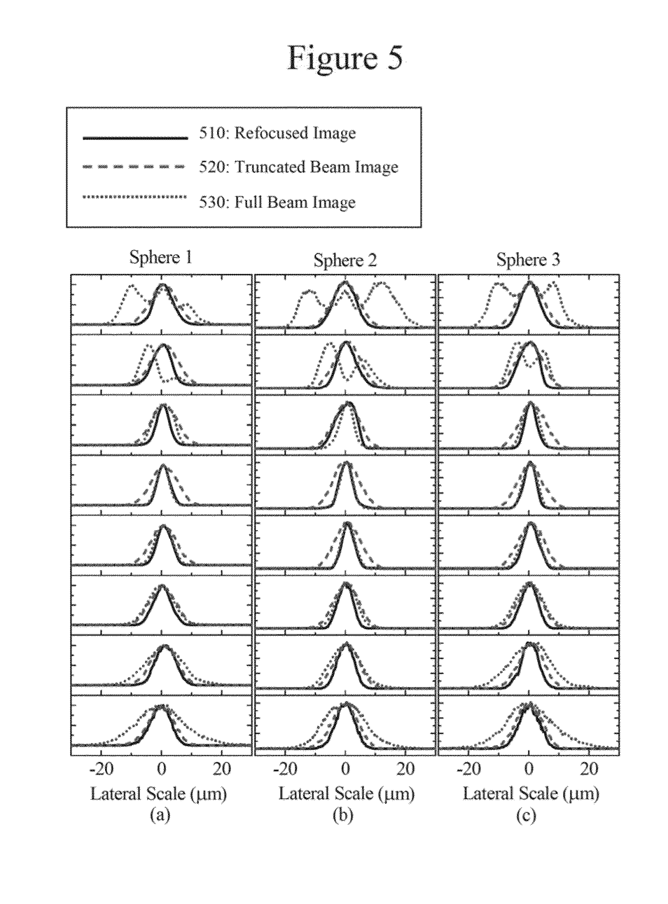

FIGS. 5(a)-5(c) show exemplary normalized intensity profiles of three spheres (1, 2, 3) selected in FIG. 4, respectively, on a linear scale. From top to bottom row profiles are shown as a function of the translation of the phantom away from the objective with 80-μm step size, corresponding to the images provided in FIG. 4. Overall, the three spheres showed a similar profile change (broad-narrow-broad) and the best focus occurred at the fourth row from the top. For the truncated beam (520) and refocused images (510), the sphere's profiles were all single-peak shaped. For the full beam image (530) however, the spheres showed a profile with side lobes in the first two rows. The behavior is consistent with the physical optics simulation, showing that the lateral profile at the depth between objective and actual focal plane exhibits multiple-maxima.

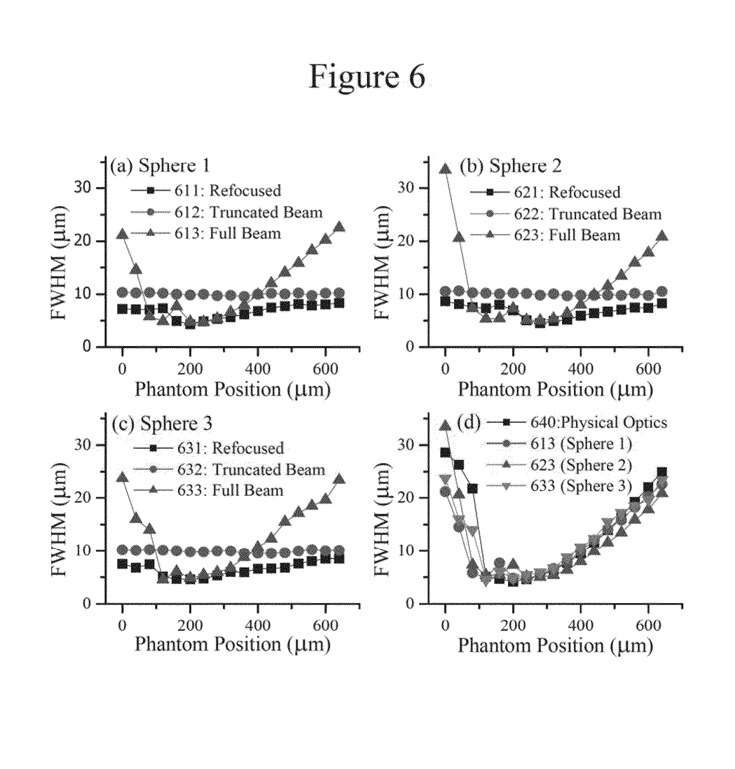

FIGS. 6(a)-6(d) show exemplary graphs of the full width at half maximum (FWHM) yielded from Gaussian fitting on the exemplary intensity profile graphs in FIGS. 5(a)-5(c). The FWHM is plotted in FIGS. 6(a)-6(d) as a function of the phantom displacement relative to the focal plane. For all three spheres, the slowest variation in FWHM during defocus occurred for the truncated Gaussian beam image (612, 622, 632) (for this image the resolution is always poor). The most rapid FWHM change is observed for the full beam image (613, 623, 633). As for the refocused image (611, 621, 631), it was focused better than the truncated Gaussian beam image (612, 622, 632) over the whole range. This can indicate that the refocusing technique, method, system and computer-accessible medium according to the exemplary embodiments of the present disclosure not only extends the depth-focus as beam truncation does, but can also produce a better resolution than that of the beam truncation.

As compared to the full beam image (613, 623, 633), the exemplary refocused image (611, 621, 631) yielded a comparable resolution within a short range around actual focal plane. Moreover, the resolution of the refocused image (611, 621, 631) degraded much more slowly than that of the full beam image (613, 623, 633). For example, spheres 1 and 3 showed the smallest FWHM in the refocused image (611, 631) and full beam image (613, 633) when the phantom was at around 200 μm. As the phantom position increased from 200 μm, the FWHM increased much more quickly for the full beam image (613, 633) than for the refocused image (611, 631). To determine the difference in depth-of-focus between the full beam and the refocused beam, the slope of the FWHM as a function of phantom position at the right side of the focus position in FIGS. 6(a)-6(c) was determined. On average, e.g., the FWHM increase in the full beam image (613, 623, 633) was about 5 times faster than the refocused image (611, 621, 631), FIG. 6(d) illustrates an exemplary comparison between the full beam FWHM (613, 623, 633) measured from the experiment and the FWHM calculated from the physical optics simulation (640). The experimental results match the simulation very well.

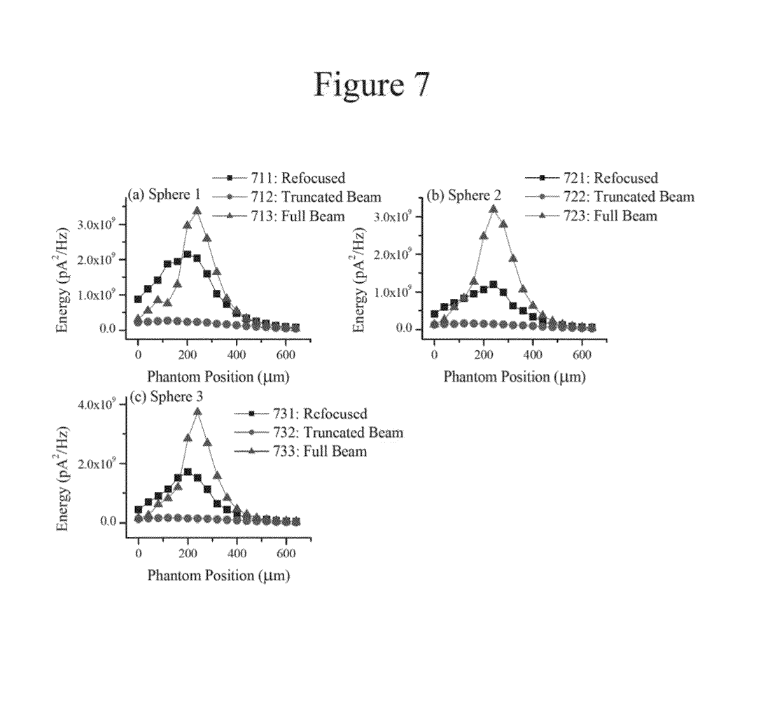

FIGS. 7(a)-7(c) illustrate exemplary graphs providing an exemplary energy efficiency of the refocusing technique utilized by the exemplary method, system and computer-accessible medium of the exemplary embodiment of the present disclosure, in comparison with the procedures utilizing the truncated beam and the Gaussian beam, e.g., where the energy of the selected spheres is provided as a function of the phantom displacement relative to the objective. For example, the energy defined as the intensity integrated over the area of the three selected spheres was calculated for three imaging modes (e.g., truncated beam (712, 722, 732), refocused (711, 721, 731), full beam imaging (713, 723, 733)). As shown in FIGS. 7(a)-7(c), in truncated beam imaging mode (712, 722, 732), the three spheres showed a slow continuous change in energy (increase-maximum-decrease). In contrast, in both the exemplary refocused imaging (711, 721, 731) and full beam imaging (713, 723, 733), the three spheres experienced a faster energy change over different phantom positions. Moreover, the energy difference between those two imaging modes was also very consistent among those three spheres. The energy efficiency of the exemplary refocusing technique (711, 721, 731) utilized by the exemplary method, system and computer-accessible medium can be evaluated on the three spheres at three depths around the optimal focus position (phantom at 200, 240, and 280 μm). The exemplary results indicate that the exemplary refocusing technique (711, 721, 731) utilized by the exemplary method, system and computer-accessible medium suffered only from, e.g., a −1.9 to −4.1 dB energy efficiency loss as compared to the full bean imaging (713, 723, 733). This is close to the expected value (−3 dB) based on the theoretical considerations.

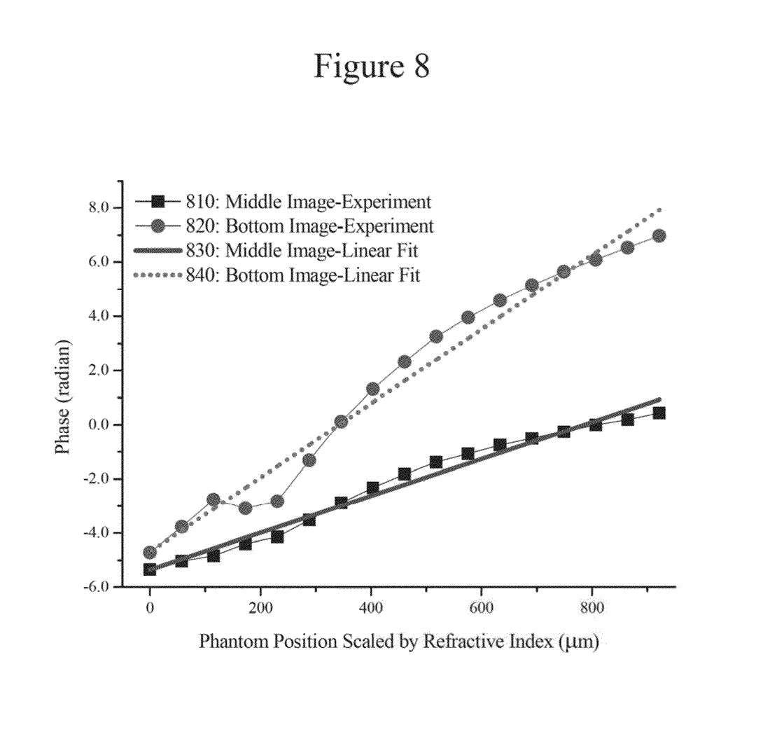

FIG. 8 illustrates an exemplary graph providing an exemplary relationship of the phase (e.g., factor) which can be used for refocusing with the defocus extent for both the middle (810) and bottom images (820). For example, the exemplary phase factors obtained based on the maximum energy criterion described above can indicate a linear relationship with the defocused depth, as predicted by theory. Moreover, the slope of the plot for the bottom image (840) was about twice of that for the middle image (830). The slopes yielded, by least square linear fitting are 6.81 and 13.69 mrad/μm, respectively. The slope for the middle image (6.81 mrad/μm) (830) is very close to the slope (7.25 mrad/μm) predicted by the physical optics simulation.

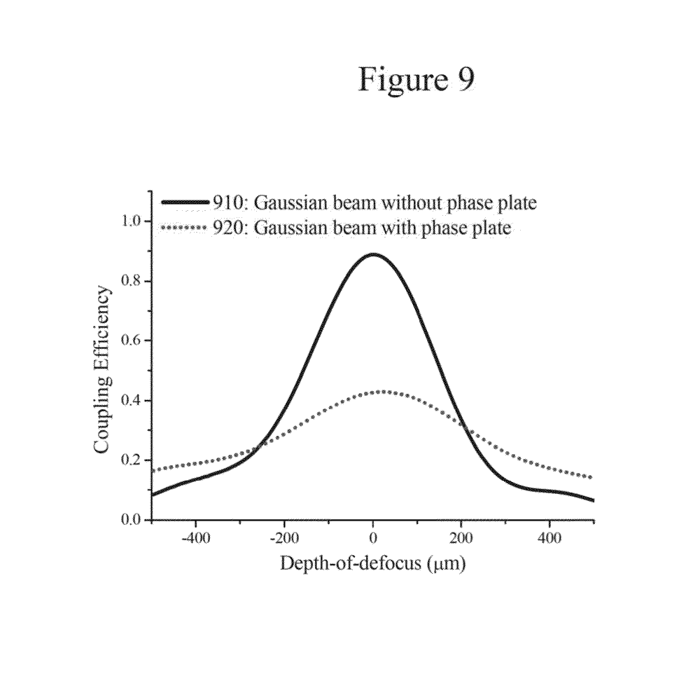

FIG. 9 illustrates an exemplary graph providing an exemplary system efficiency of conventional Gaussian beam imaging without phase plate (910) and with phase plate (920) using physical optics simulation. As seen in FIG. 9, e.g., when the defocus becomes larger than about 250 μm (corresponding to about 2 times Rayleigh range), the introduction of phase plate can actually gain a little efficiency as compared to the case of no phase plate.

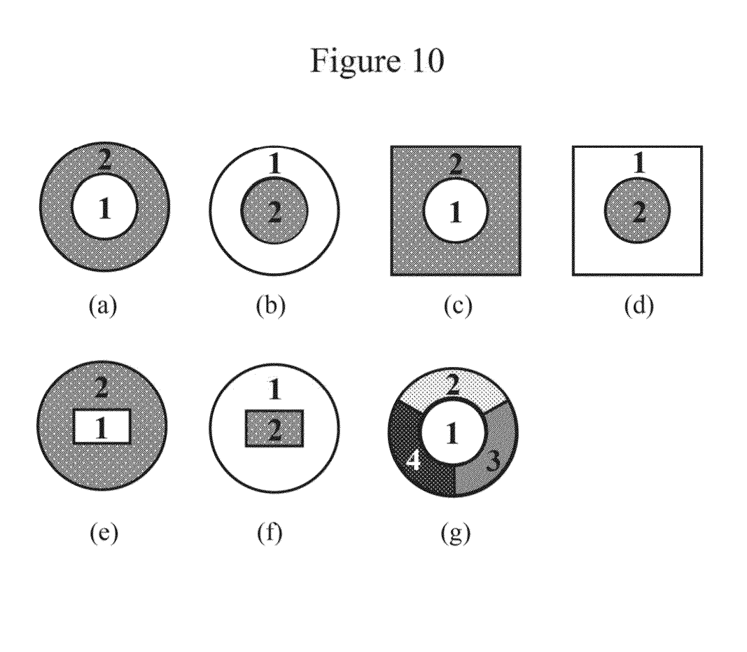

FIG. 10 shows exemplary designs of several different possible phase plates for the synthetic aperture OCT system, method and computer-accessible medium according to the exemplary embodiments of the present disclosure.

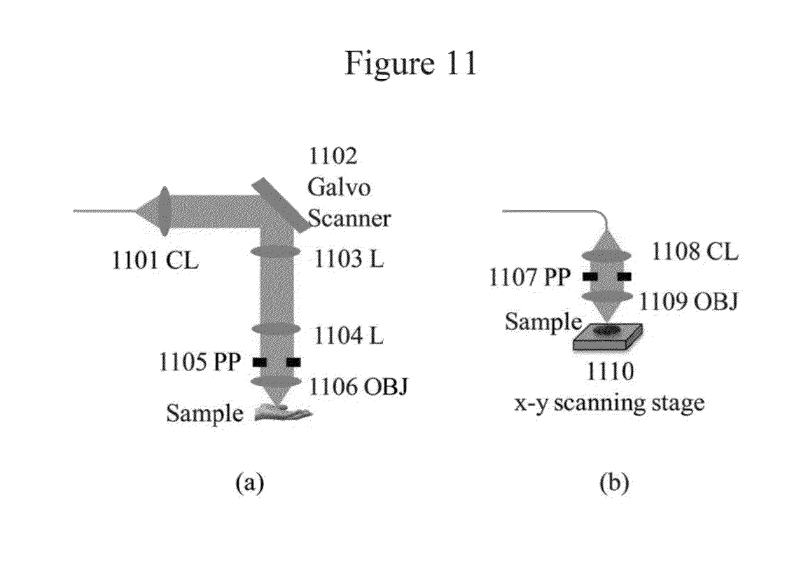

FIG. 11 illustrates exemplary schematic diagrams of the exemplary systems according to the present disclosure providing different exemplary sample arm design with phase plates. For example, the phase plate (PP) (1105, 1107) can be positioned at the real back focal plane. The galvo scanner (1102) can be provided at relayed backfocal plane by a pair of lens (1103, 1104). Alternatively, beam scanning by the galvo scanner can be replaced by sample scanning using, e.g., a motorized translation stage (1110).

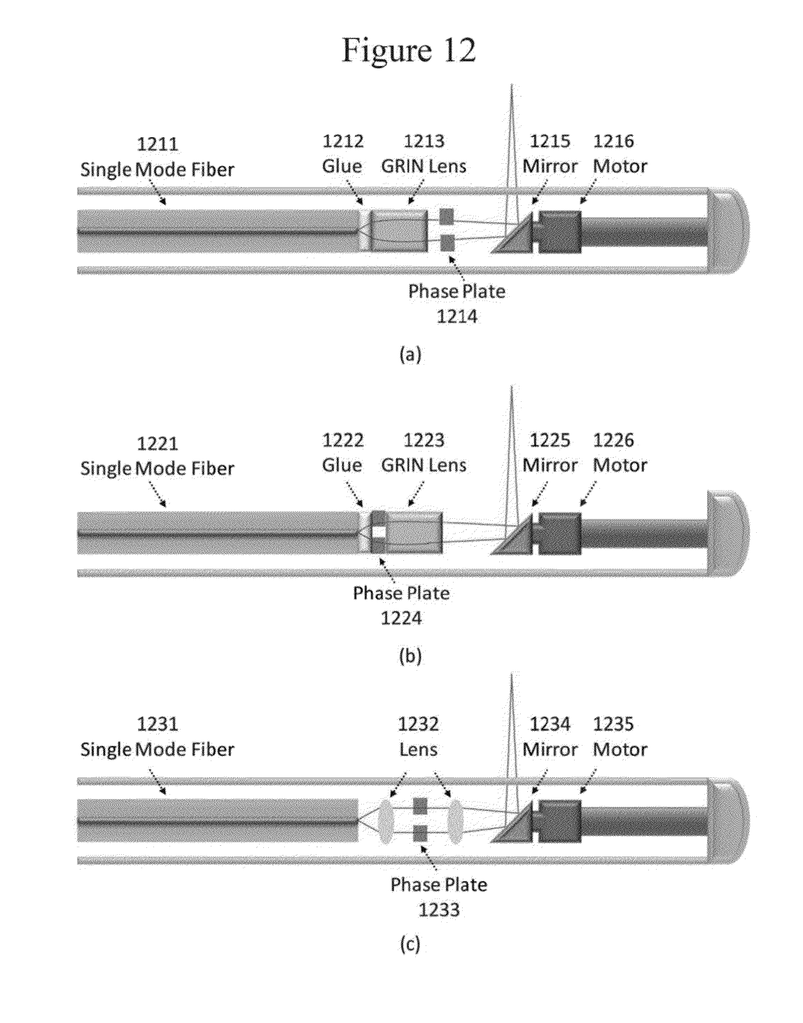

FIGS. 12(a)-12(c) show a set of schematic diagrams of three different OCT catheter designs with respective phase plates according to further exemplary embodiments of the present disclosure. For example, the phase plate (1214, 1224,) can be positioned before or after a GRIN or other type lens (1213, 1223). Alternatively, the phase plate (1233) can be positioned in the back focal plane of an imaging lens beam 1212).

The foregoing merely illustrates the principles of the disclosure. Various modifications and alterations to the described embodiments will be apparent to those skilled in the art in view of the teachings herein. Indeed, the arrangements, systems and methods according to the exemplary embodiments of the present disclosure can be used with and/or implemented in any OCT system, OFDI system, SD-OCT system or other imaging systems, and for example with those described in International Patent Application PCT/US2004/029148, filed Sep. 8, 2004 which published as International Patent Publication No. WO 2005/047813 on May 26, 2005, U.S. patent application Ser. No. 11/266,779, filed Nov. 2, 2005 which published as Patent Publication No. 2006/0093276 on May 4, 2006, and U.S. patent application Ser. No. 10/501,276, filed Jul. 9, 2004 which published as U.S. Patent Publication No. 2005/0018201 on Jan. 27, 2005, and U.S. Patent Publication No. 2002/0122246, published on May 9, 2002, the disclosures of which are incorporated by reference herein in their entireties. It will thus be appreciated that those skilled in the art will be able to devise numerous systems, arrangements, and procedures which, although not explicitly shown or described herein, embody the principles of the disclosure and can be thus within the spirit and scope of the disclosure. In addition, all publications and references referred to above can be incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, main frame, etc., including a plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it can be explicitly being incorporated herein in its entirety. All publications referenced above can be incorporated herein by reference in their entireties:

### EXEMPLARY REFERENCES

1. D. Huang, E. A. Swanson, C. P. Lin, J. S. Schuman, W. G. Stinson, W. Chang, M. R. Hee, T. Flotte, K. Gregory and C. A. Puliafito, “Optical coherence tomography,” Science 254, 1178-1181 (1991).
2. S. Yun, G. Tearney, B. Bouma, B. Park, and J. de Boer, “High-speed spectral-domain optical coherence tomography at 1.3 μm wavelength,” Opt. Express 11, 3598-3604 (2003),
3. S. Yun, G. Tearney, J. de Boer, N. Iftimia, and B. Bouma, “High-speed optical frequency-domain imaging,” Opt. Express 11, 2953-2963 (2003).
4. J. M. Schmitt, S. L. Lee, and K. M. Yung, “An optical coherence microscope with enhanced resolving power in thick tissue.” Optics Communications 142, 203-207 (1997).
5. B. Qi, A. Phillip Himmer, L. Maggie Gordon, X. D. Victor Yang, L. David Dickensheets, and I. Alex Vitkin, “Dynamic focus control in high-speed optical coherence tomography based on a microelectromechanical mirror,” Optics Communications 232, 123-128 (2004).
6. A. S. Beau, K. C. L. Kenneth, M. Adrian, R. M. Nigel, K. K. L. Michael, X. D. Y. Victor, and I. A. Vitkin, “In vivo endoscopic multi-beam optical coherence tomography,” Physics in Medicine and Biology 55, 615 (2010).
7. Z. Ding, H. Ren, Y. Zhao, S. S. Nelson, and Z. Chen, “High-resolution optical coherence tomography over a large depth range with an axion lens,” Opt. Lett. 27, 243-245 (2002).
8. R. A. Leitgeb, M. Villiger, A. H. Bachmann, L. Steinmann, and T. Lasser, “Extended focus depth for Fourier domain optical coherence microscopy,” Opt. Lett. 31, 2450-2452 (2006).
9. L. Lin, C. Lin, W. C. Howe, C. J. R. Sheppard, and N. Chen, “Binary-phase spatial filter for real-time swept-source optical coherence microscopy,” Opt. Lett. 32, 2375-2377 (2007).
10. T. S. Ralston, D. L. Marks, P. Scott Carney, and S. A. Boppart, “Interferometric synthetic aperture microscopy,” Nat Phys 3, 129-134 (2007).
11. Y. Yasuno, J.-i. Sugisaka, Y. Sando, Y. Nakamura, S. Makita, M. Itoh, and T. Yatagai, “Non-iterative numerical method for laterally superresolving Fourier domain optical coherence tomography,” Opt. Express 14, 1006-1020 (2006).
12. L. Yu, B. Rao, J. Zhang, J. Su, Q. Wang, S. Guo, and Z. Chen, “Improved lateral resolution in optical coherence tomography by digital focusing using two-dimensional numerical diffraction method,” Opt. Express 15, 7634-7641 (2007).
13. M. de Groot, C. L. Evans, and J. F. de Boer. “Self-interference fluorescence microscopy: three dimensional fluorescence imaging without depth scanning,” Opt. Express 20, 15253-15262 (2012).

What is claimed is:

1. An apparatus for generating at least one image of a structure, comprising:
at least one first arrangement including a structural configuration that has a first aperture and a second aperture;
at least one detector second arrangement which is configured to detect (i) a first electro-magnetic signal provided to or from the structure via the first aperture, and (ii) a second electro-magnetic signal provided to or from the structure via the second aperture, wherein the first and second signals are associated with data regarding at least one portion of the structure; and
at least one processing third arrangement which is configured to combine an amplitude and a phase of each of the first and second signals with one another to form a combined amplitude and a combined phase of a combined signal, and then generate the at least one image based on the combined signal.

2. The apparatus according to claim 1, wherein at least one of the first signal or the second signal is an optical coherence tomography signal.

3. The apparatus according to claim 1, wherein the first and second signals are provided at different depths of an optical coherence tomography depth profile of the structure.

4. The apparatus according to claim 1, wherein the structural configuration includes a third aperture, wherein the at least one detector second arrangement is configured to detect a third electro-magnetic signal associated with data regarding the at least one portion of the structure provided from the structure via the third aperture, and wherein the at least one processing third arrangement is further configured to combine an amplitude and a phase of each of the first, second and third signals with one another to form the combined amplitude and the combined phase of the combined signal.

5. The apparatus according to claim 4, wherein, prior to forming the combined amplitude and the combined phase of the combined signal, the at least one processing third arrangement is configured to actively manipulate the phase of at least one of the first signal, the second signal or the third signal.

6. The apparatus according to claim 5, wherein the at least one processing third arrangement is further configured to actively manipulate the phase of at least one of the first signal, the second signal or the third signal differently for separate sections of the structure which are provided at different depths thereof.

7. The apparatus according to claim 6, wherein an amount of the manipulation of the phase of at least one of the first signal, the second signal or the third signal is optimizable with a criteria related to at least one property of the image at a particular depth.

8. The apparatus according to claim 1, wherein the structure is a biological structure.

9. The apparatus according to claim 1, wherein the structural configuration includes a material that provides (i) the first and second apertures therein, and (ii) a path length of the first signal that is different from a path length of the second signal.

10. The apparatus according to claim 1, wherein a difference between the path lengths of the first and second signals is greater than a length or a thickness of the at least one portion of the structure being imaged.

11. The apparatus according to claim 1, wherein the material includes at least one of a glass, a phase grating, a deformable mirror, or a spatial phase modulator.

12. The apparatus according to claim 1, wherein the at least one detector second arrangement includes at least one single-mode fiber which collects the first and second signals.

13. The apparatus according to claim 1, wherein the at least one first arrangement is provided in an endoscope.

14. The apparatus according to claim 1, wherein the structural configuration has first and second structures, the first structure including the first aperture, and the second structure including the second aperture.

15. The apparatus according to claim 1, wherein the at least one first arrangement is provided in a microscope.
